(19) United States
(12) Patent Application Publication
(10) Pub. No.: US 2011/0115697 A1
(43) Pub. Date: May 19, 2011

(54) USER INFORMATION PROVISION DEVICE, USER INFORMATION PRESENTATION SYSTEM, AND USER INFORMATION PRESENTATION METHOD

(76) Inventors: Kazuhiro Sakata, Tokyo (JP); Shuntaro Yamazaki, Tokyo (JP)

(21) Appl. No.: 12/812,771

(22) PCT Filed: Jan. 16, 2009
(86) PCT No.: PCT/JP2009/050536

§ 371 Date: Jul. 14, 2010

(30) Foreign Application Priority Data
Jan. 18, 2008 (JP) 2008-009120

(51) Int. Cl. G06F 3/01

(52) U.S. Cl. 345/156

(57) ABSTRACT

There are included: an information provision apparatus to which user's position information is input; and a display device that displays information on the user, the information being output from the information provision apparatus. The information provision apparatus includes: a user information storing unit that stores the information on the user; a display device information storing unit that stores information on an intended display range of the display device; and a display control unit that transmits the information on the user stored in the user information storing unit to the display device when a position of the user falls within the intended display range of the display device.

### TECHNICAL FIELD

The present invention relates to a user information provision apparatus, an information presentation system, and a user information presentation method for presenting information on users.

### BACKGROUND ART

In companies and other organizations, communication and information sharing between organization members are important in improving the organizations' productivity.

Among systems for promoting communication and information sharing between people is the system described in PTL 1 (knowledge sharing promotion system).

The system is composed of portable terminals that are capable of infrared communication, and a display device that is located in a predetermined position and is capable of infrared communication.

The portable terminals contain user's personal profile information and history information. The portable terminals are held by the users.

In the system of PTL 1, agents are displayed on the display device when the users operate the portable terminals in the coverage of infrared communication of the display device. Here, the agents refer to character images corresponding to the respective users.

The plurality of agents displayed on the screen of the display device present pseudo conversations on-screen based on the users' personal information. With the presented information, communication and information sharing between the users is promoted.

As described above, in the system of PTL 1, the personal information on users in the vicinity of the display device is presented by the display device, whereby communication and information sharing between the persons is promoted.

### CITATION LIST

### Patent Literature

{PTL 1} JP-B-3611509

### SUMMARY OF INVENTION

### Technical Problem

In the system of PTL 1, however, the range of positions of users to be displayed on the display device is simply determined by the distance to the display device. Specifically, whether or not to display a user is determined by whether the user's portable terminal and the display device are within the coverage of infrared communication.

The system of PTL 1 therefore has the disadvantage that it is not possible for the system administrator to flexibly change the range of positions of users to be displayed on the display device.

It is thus an exemplary object of the present invention to provide a user information provision apparatus, a user information presentation system, and a user information presentation method by which an administrator can arbitrarily set the range of users to be displayed on a display device.

### Solution to Problem

According to an exemplary first aspect of the present invention, there is provided, as a system, a user information presentation system including: an information provision apparatus to which user's position information is input; and
a display device that displays information on the user, the information being output from the information provision apparatus,
the information provision apparatus including
a user information storing unit that stores the information on the user,
a display device information storing unit that stores information on an intended display range of the display device, and
a display control unit that transmits the information on the user stored in the user information storing unit to the display device when a position of the user falls within the intended display range of the display device.

According to an exemplary second aspect of the present invention, there is provided, as an apparatus, an information provision apparatus to which user's position information is input and which transmits information on the user to a display device, the apparatus including:
a user information storing unit that stores the information on the user;
a display device information storing unit that stores information on an intended display range of the display device; and
a display control unit that transmits the information on the user stored in the user information storing unit to the display device when a position of the user falls within the intended display range of the display device.

According to an exemplary third aspect of the present invention, there is provided, as an apparatus, an information provision apparatus including: a display unit that displays information on a user;
a user information storing unit that stores the information on the user;
a display unit information storing unit that stores information on an intended display range of the display unit; and
a display control unit that outputs the information on the user stored in the user information storing unit to the display unit when a position of the user which is input falls within the intended display range of the display unit.

According to an exemplary fourth aspect of the present invention, there is provided, as a method, an information provision method of an information provision apparatus to which user's position information is input and which transmits information on the user to a display device, the method including:
acquiring information on an intended display range of the display device from a display device information storing unit;
acquiring the information on the user from a user information storing unit when a position of the user falls within the intended display range of the display device; and
transmitting the acquired information on the user to the display device.

According to an exemplary fifth aspect of the present invention, there is provided, as a method, an information provision method of an information provision apparatus to which user's position information is input and which displays information on the user on a display unit, the method including:
acquiring information on an intended display range of the display unit from a display unit information storing unit;
acquiring the information on the user from a user information storing unit when a position of the user falls within the intended display range of the display unit; and
displaying the acquired information on the user on the display unit.

This application is based upon and claims the benefit of priority from prior Japanese Patent Application No. 2008-009120, filed 18 Jan. 2008. The contents of Japanese Patent Application No. 2008-009120 will be incorporated in the contents of description of this application.

### Advantageous Effects of Invention

According to the present invention, it is possible for the system administrator to flexibly set the range of positions of users to be displayed on a display device.

### BRIEF DESCRIPTION OF DRAWINGS

FIG. 1 A block diagram showing the main configuration of a user information presentation system according to an embodiment of the present invention.

FIG. 2 A diagram showing an example of data stored in a user information storing unit of the user information presentation system according to the embodiment of the present invention.

FIG. 3 A diagram showing an example of the environment where the user information presentation system according to the embodiment of the present invention operates.

FIG. 4 A diagram showing an example of data stored in a display device information storing unit of the user information presentation system according to the embodiment of the present invention.

FIG. 5 A flowchart showing the processing procedure that is performed in a display control unit of the user information presentation system according to the embodiment of the present invention.

FIG. 6 A diagram showing an example of a video picture that is output to a display device of the user information presentation system according to the embodiment of the present invention.

FIG. 7 A block diagram showing the configuration of an information provision apparatus according to another embodiment of the present invention.

FIG. 8 A block diagram showing an example of the configuration of a computer that constitutes the information provision apparatus according to the present embodiment.

### REFERENCE SIGNS LIST

50: network
100: information provision apparatus
110: positioning unit
120: display control unit
130: user information storing unit
140: display device information storing unit
200, 201, 202: display device
300: positioning system

### DESCRIPTION OF EMBODIMENTS

Next, an exemplary embodiment of the present invention will be described in detail with reference to the drawings.

### [System Configuration]

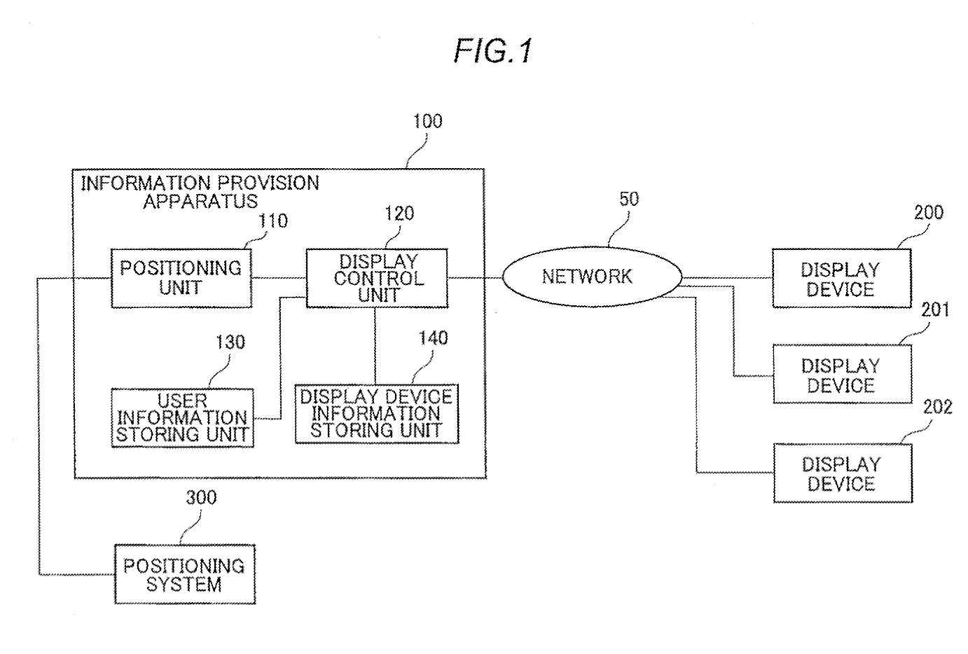

FIG. 1 shows the main configuration of a user information presentation system according to the present embodiment.

The system of the present embodiment includes an information provision apparatus 100, three display devices 200, 201, and 202, and a network 50 that connects the information provision apparatus 100 with the display device 200. The three display devices are provided here, but the number of display devices is not limited thereto and may be one. A positioning system 300 outputs user's position information to the information provision apparatus 100. The display devices may be liquid crystal displays, plasma displays, projection-type liquid crystal projectors for projecting display on a screen.

The information provision apparatus 100 includes: a positioning unit 110 which has the function of acquiring the user's position information from the positioning system 300; a display control unit 120 which has the function of controlling the display contents on the display device 200; a user information storing unit 130 which has the function of storing user information; and a display device information storing unit 140 which has the function of storing information on the display device 200.

The positioning system 300 has the function of acquiring and providing user's position information. Now, an example of the configuration of the positioning system 300 will be described.

The positioning system 300 includes, for example, a plurality of portable terminals that have a GPS (Global Positioning System) function and a communication function, and a positioning server that acquires the results of GPS-based positioning from the portable terminals.

The portable terminals are carried by users. When user's position information is requested, the positioning server performs communication with the portable terminals, acquires the position information acquired by the GPS functions of the portable terminals, and offers a response to the requestor.

In this way, the positioning system 300 achieves the provision of user's position information.

It should be noted that the configuration and the method of positioning of the positioning system 300 described above are an example, and any other configurations may be used as long as user's position information can be acquired and provided.

The user information storing unit 130 stores user information. Examples of the user information to be stored include profile information such as the department and name of the user.

Another example is information on the shape of an avatar which is a character displayed on-screen as the user's alter ego.

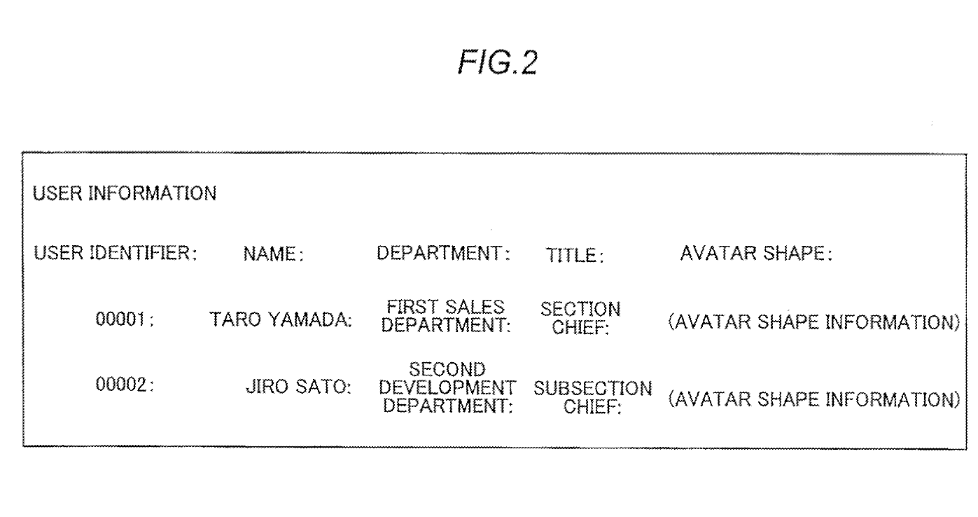

FIG. 2 shows an example of the user information stored in the user information storing unit 130.

In the example, information on a user's identifier, name, department, job title, and avatar shape is stored user by user.

For example, the line “00001: Taro Yamada: First Sales Department: Section chief: (avatar shape information)” means that the user who has the user-identifying identifier 00001 has the name Taro Yamada, belongs to First Sales Department, and is section chief. The line “00002: Jiro Sato: Second Development Department: Subsection chief: (avatar shape information)” means that the user who has the user-identifying identifier 00002 has the name Jiro Sato, belongs to Second Development Department, and is subsection chief.

It should be appreciated that the pieces of information shown in FIG. 2 are illustrative only, and the user information storing unit 130 may contain information other than illustrated as long as the information pertains to the users.

The display device information storing unit 140 contains information on the intended display ranges of the respective display devices.

The system administrator can set the information on the users in advance.

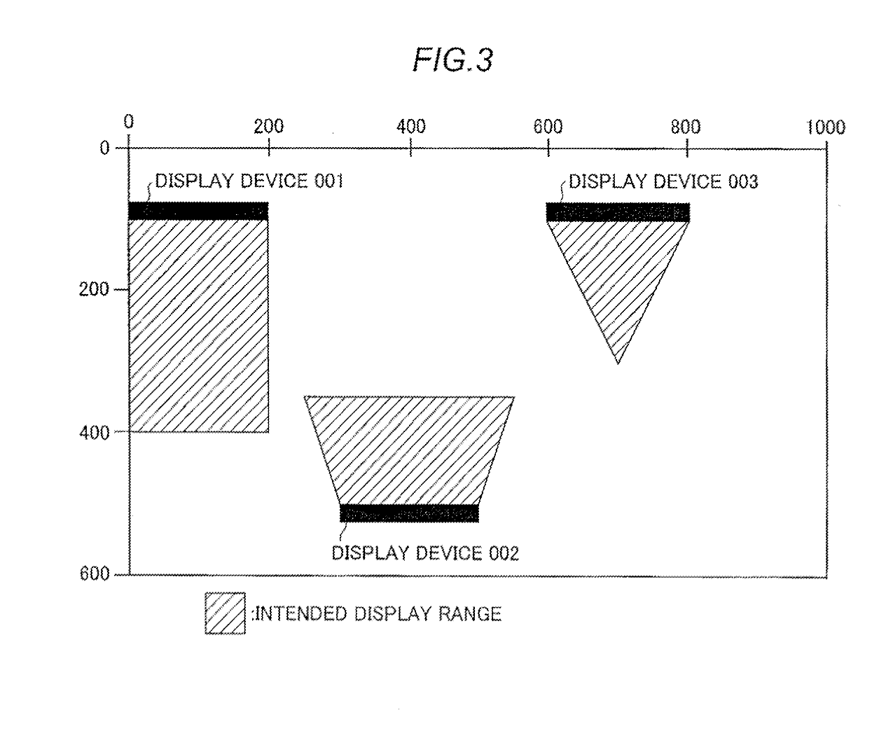

The information to be stored in the display device information storing unit 140 will now be described with reference to a specific floor plan. FIG. 3 is a diagram showing an example of the environment where the present system operates. The diagram provides a view of a certain room as seen from above, showing the layout of the display devices and the intended display ranges of the respective display devices. The information on a user is displayed on the display devices if it is determined from the user's position information that the user is in the ranges.

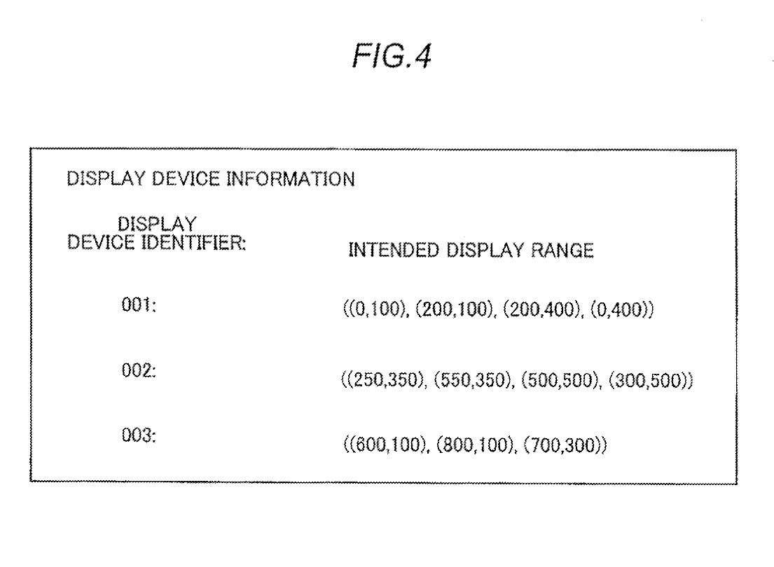

In the example, there are arranged three display devices with display ranges of respective different shapes. FIG. 4 shows the information in the display device information storing unit corresponding to such an example.

Here, the intended display range corresponding to each display device is expressed by a set of coordinates that are picked up clockwise from the vertex coordinates of the range.

The display device 200 shown in FIG. 1 corresponds to the display device with an identifier of “001”, the display device 201 corresponds to the display device with an identifier of “002”, and the display device 202 corresponds to the display device with an identifier of “003”. For example, the line “001: ((0,100),(200,100),(200,400),(0,400))” means that the display device with the identifier “001” has an intended display range that is formed by connecting the four coordinates (0,100), (200,100), (200,400), and (0,400) in order. The line “002: ((250,350),(550,350),(500,500),(300,500))” means that the display device with the identifier “002” has an intended display range that is formed by connecting the four coordinates (250,350), (550,350), (500,500), and (300,500) in order. The line “003: ((600,100),(800,100),(700,300))” means that the display device with the identifier “003” has an intended display range that is formed by connecting the three coordinates (600,100), (800,100), and (700,300) in order.

In this way, the display device information storing unit 140 manages the correspondence between the display devices and the intended display ranges. It should be appreciated that the method of expression of the intended display ranges is just an example, and any other method of expression may be used as long as the system can identify the intended display ranges.

### [System Operation].

Next, the operation of the user information presentation system according to the present embodiment will be described in detail. The processing for providing user information is chiefly executed by the display control unit 120.

Hereinafter, the processing of the display control unit 120 will be described in detail with reference to the drawings.

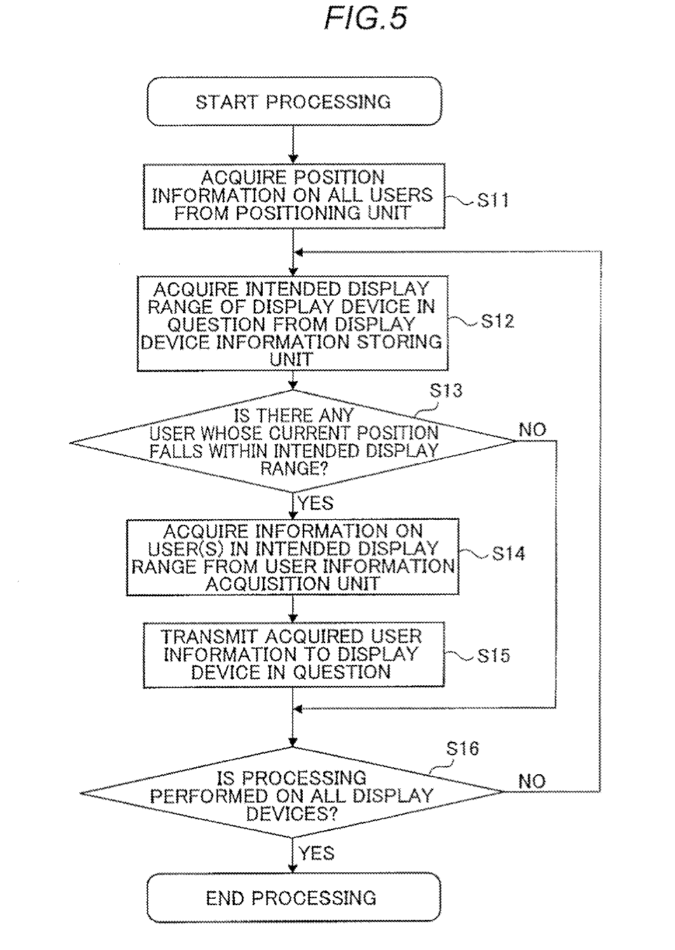

FIG. 5 is a diagram showing the processing procedure of the display control unit 120. The display control unit 120 repeats the processing shown in FIG. 5 at regular time intervals.

Initially, the display control unit 120 acquires position information on predetermined users from the positioning unit 110 (step S11).

Specifically, the display control unit 120 acquires sets of information on the user identifier and position information, on the system users.

Next, the display unit 120 successively performs the processing of steps S12 and later on the predetermined display device 200 that is registered in the display device information storing unit 140.

The display control unit 120 initially acquires the information on the intended display ranges of the display devices 200, 201, and 202 to be processed this time from the display device information storing unit 140 (step S12).

Next, the display control unit 120 compares the pieces of position information on the users acquired at step S11 with the intended display range acquired at step S12, and determines whether there is any user in the intended display range of the display device 200 (step S13).

If at step S13 there is one or more users in the intended display range of the display device 200 (YES at step S13), the display control unit 120 acquires information corresponding to the user(s) lying in the intended display range from the user information storing unit 130 (step S14).

Next, the display control unit 120 generates video information to be output to the display device 200 by using the user information acquired at step S14, and transmits the video information to the display device 200 through the network 50 (step S15). For example, if the two users shown in FIG. 2 are in the intended display range of the display device 200 with the identifier “001”, the display control unit 120 transmits the information shown in FIG. 2 to the display device 200.

The display device 200 outputs the received video information on-screen.

The video picture to be generated and displayed here has contents that provide the information on the users to viewers who watch the video picture.

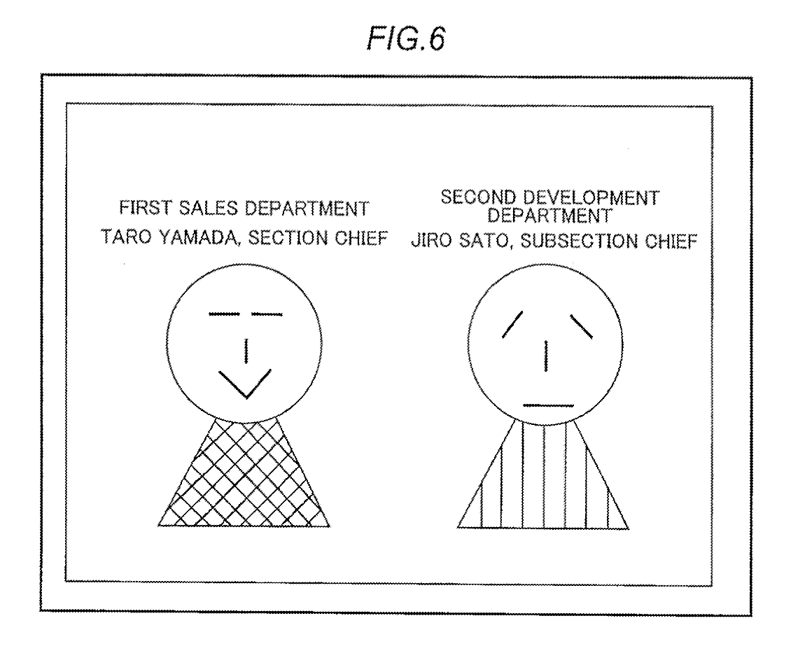

FIG. 6 shows an example of the video picture for the display device 200 to output.

In the example, the avatars corresponding to the two users are displayed along with the profile information.

For example, the left character in FIG. 6 corresponds to the user with the name “Taro Yamada”, showing the department “First Sales Department” and the title “Section chief.” The left character in FIG. 6 corresponds to the user with the name “Jiro Sato”, showing the department “Second Development Department” and the title “Subsection chief.”

It should be appreciated that such a video picture is just an example, and video pictures of any other contents or the video picture of FIG. 6 accompanied with other pictures may be displayed as long as the video pictures express the user information.

If at step S13 there is no user in the intended display range of the display device 200 (NO at step S13), the display control unit 120 ends the processing for the display device 200.

Next, the display control unit 120 determines whether the foregoing processing of steps S12 to S15 is performed on all the display devices 200, 201, and 202. If the processing is performed on all the display devices 200, 201, and 202, the display control unit 120 ends the processing. On the other hand, if there is any display device yet to be processed, the display control unit 120 repeats the processing of steps S12 to S15 (step S16). Since the display devices 201 and 202 are yet to be processed here, the processing of steps S12 to S15 is repeated on the display devices 201 and 202.

By the processing described above, the system of the present embodiment outputs the user information to the display devices 200, 201, and 202 based on the information on the intended display ranges stored in the display device information storing unit 140. Note that while in the flowchart of FIG. 5 the processing of steps S12 to S15 is performed on the display devices 200, 201, and 202 by turns, the display control unit 120 may simultaneously perform the processing on the display devices 200, 201, and 202 and transmit video information to the display devices.

### Modifications of Embodiment

The foregoing embodiment has dealt with the case where the display control unit 120 generates video information and transmits the information to the display devices 200, 201, and 202.

Instead, the display control unit 120 may transmit user information needed for video pictures to the display devices 200, 201, and 202 so that the display device 200 can generate and display video pictures based on the user information. That is, the display devices 200, 201, and 202 may have the function of generating video information from the user information and displaying the video information.

The foregoing embodiment has also dealt with the case where the video pictures of the users to be displayed on the display devices 200, 201, and 202 are determined by the user information stored in the user information storing unit 130.

Instead, the display control unit 130 may determine the video pictures by using not only the user information stored in the user information storing unit 130 but other information as well.

For example, users' behavior may be measured by some kind of sensors, and the users' avatars to be displayed may be modified in shape based on the result of measurement. Alternatively, for example, users' presence information may be acquired, and the users' avatars to be displayed may be modified in shape based on the result of acquisition. Alternatively, for example, information on the number of users in an intended display range may be acquired, and the users' avatars to be displayed may be modified in shape and size based on the result of acquisition.

While the embodiment has dealt with video pictures, images may be used instead.

The use of the embodiment of the present invention described above provides the following effects.

One of the effects is that, in the system that outputs information on users who are in the vicinity of display devices to the display devices, the system administrator can flexibly change the ranges of display of users on the display devices.

Another effect is that the ranges of display of users on the display devices, determined by the system administrator, are unaffected by external factors such as a user movement.

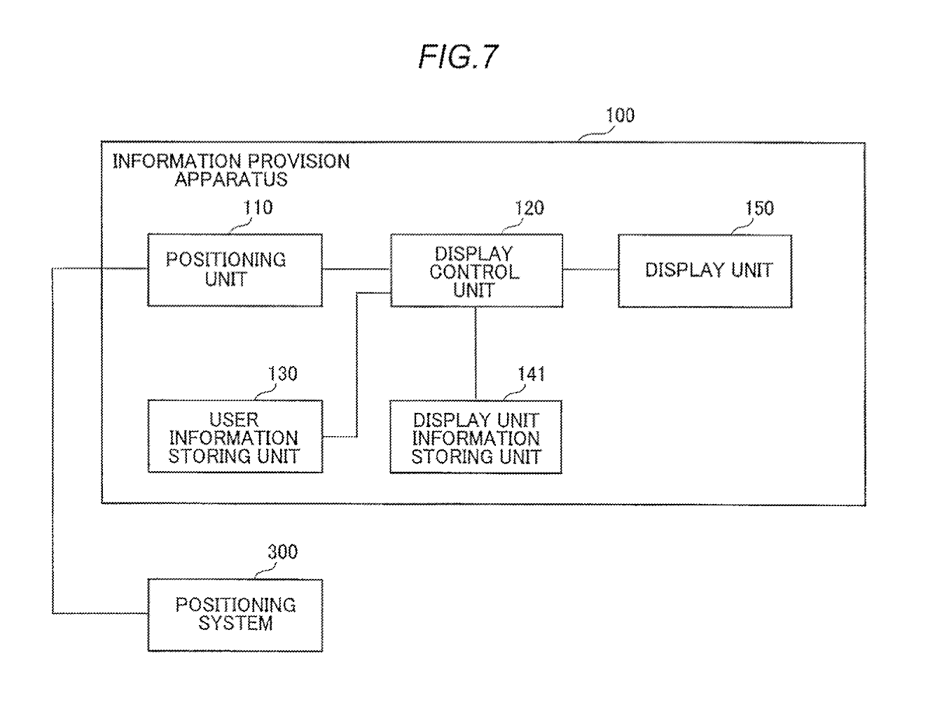

While the information provision apparatus shown in FIG. 1 is separate from the display devices, the information provision apparatus may include a display unit 150 as shown in FIG. 7. FIG. 7 is a block diagram showing the configuration of the information provision apparatus according to another embodiment of the present invention. The configuration of FIG. 7 is the same as in FIG. 1 except that a display unit information storing unit 141 having the same functions as those of the display device information storing unit 140 is provided instead of the display device information storing unit 140.

Another effect is that the system administrator can flexibly change the information to be displayed on the display devices.

The user information presentation system and the information provision apparatus, the embodiments of the present invention, may be implemented by hardware, software, or a combination thereof. When constructing the information provision apparatus by software, a program that describes the procedure shown in FIG. 5 (the procedure showing the functions of the positioning unit 110 and the display control unit 120) may be stored in a storage unit such as a hard disk. According to the program, a control unit or CPU can execute the processing (control) to implement the functions of the user information presentation system.

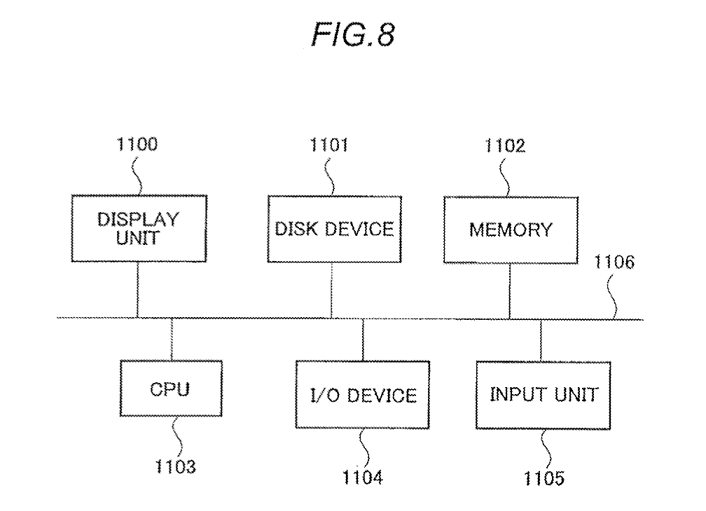

FIG. 8 is a block diagram showing an example of the configuration of a computer that constitutes the information provision apparatus according to the present embodiment.

A program that describes the functions of the positioning unit 110 and the display control unit 120 of the information provision apparatus 110 shown in FIG. 1 is stored in a disk device 1101 such as a hard disk drive. The data of the user information storing unit 130 and the display device information storing unit 140 is stored in the disk device 1101. A CPU 1100 executes the program that implements the functions of the positioning unit 110 and the display control unit 120. An input unit 1105 is an input device such as a keyboard, and inputs information (for example, the information shown in FIG. 2) to be recorded in the disk device 1101 which serves as the user information storing unit 130 and the display information storing unit 140. A display unit 1100 is a liquid crystal display, plasma display, or the like. The reference sign 1106 represents a bus such as a data bus, and The reference sign 1102 represents a DRAM or other memory that contains information necessary for the information processing of the CPU 1103. An I/O device 1104 serves as a communication unit that transmits information to the display devices 200 to 202 of FIG. 1.

The program (also referred to as a program product) may be stored in a computer-readable information recording medium such as a FD (floppy disk), CD-ROM, DVD, and flash memory. While in FIG. 8 a disk device is used as the storage unit, the program recorded on the computer-readable information recording medium such as FD and CD-ROM may be read into the disk device of the computer so that the processing can be performed to implement the functions of the information provision apparatus.

Up to this point, representative embodiments of the present invention have been described. However, the present invention may be carried out in various other forms without departing from its spirit or essential characteristics set forth by the appended claims. The foregoing embodiments are therefore to be considered as mere illustrative and not restrictive. The scope of the invention is given by the appended claims, and is not restricted by the foregoing description or abstract. All changes and modifications which come within the meaning and range of equivalency of the claims are intended to be embraced within the scope of the present invention.

1-8. (canceled)

9. A user information presentation system comprising:
an information provision apparatus that transmits information on a user to a display device; and
a positioning apparatus that measures a position of the user,
the information provision apparatus including
a user information storing unit that stores the information on the user,
a display device information storing unit that stores an intended display range in association with the display device, the intended display range being defined as a condition of a position of a user to be displayed on the display device and being settable in an arbitrary shape, and
a display control unit that determines whether the measured position of the user falls within the intended display range, and if the position falls within the intended display range, transmits the information on the user to the display device associated with the intended display range.

10. The user information presentation system according to claim 9, wherein the information on the user includes a character image corresponding to the user.

11. An information provision apparatus to which user's position information is input and which transmits information on the user to a display device, said apparatus comprising:
a user information storing unit that stores the information on the user;
a display device information storing unit that stores an intended display range in association with the display device, the intended display range being defined as a condition of a position of a user to be displayed on the display device and being settable in an arbitrary shape; and
a display control unit that determines whether a position of the user falls within the intended display range, and if the position falls within the intended display range, transmits the information on the user to the display device associated with the intended display range.

12. An information provision apparatus comprising:
a display unit that displays information on a user;
a user information storing unit that stores the information on the user;
a display unit information storing unit that stores an intended display range which is defined as a condition of a position of a user to be displayed on the display unit and is settable in an arbitrary shape; and
a display control unit that determines whether a position of the user which is input falls within the intended display range, and if the position falls within the intended display range, outputs the information on the user to the display unit.

13. The information provision apparatus according to claim 11, wherein the information on the user includes a character image corresponding to the user.

14. An information provision method of an information provision apparatus to which user's position information is input and which transmits information on the user to a display device, said method comprising:
storing an intended display range in association with the display device into a display device information storing unit, the intended display range being defined as a condition of a position of a user to be displayed on the display device and being settable in an arbitrary shape;
acquiring information on the intended display range from the display device information storing unit;
determining whether a position of the user falls within the intended display range, and if the position falls within the intended display range, acquiring the information on the user from a user information storing unit; and
transmitting the acquired information on the user to the display device associated with the intended display range.

15. An information provision method of an information provision apparatus to which user's position information is input and which displays information on the user on a display unit, said method comprising:
storing an intended display range into a display unit information storing unit, the intended display range being defined as a condition of a position of a user to be displayed on the display unit and being settable in an arbitrary shape;
acquiring information on the intended display range of the display unit from the display unit information storing unit;
determining whether a position of the user falls within the intended display range, and if the position falls within the intended display range, acquiring the information on the user from a user information storing unit; and
displaying the acquired information on the user on the display unit.

16. The information provision method according to claim 14, wherein the information on the user includes a character image corresponding to the user.

17. The information provision apparatus according to claim 12, wherein the information on the user includes a character image corresponding to the user.

18. The information provision method according to claim 15, wherein the information on the user includes a character image corresponding to the user.
